(19) United States
(12) Patent Application Publication
(10) Pub. No.: US 2006/0016994 A1
(43) Pub. Date: Jan. 26, 2006

(54) System and method to prevent cross-talk between a transmitter and a receiver

(76) Inventors: Suresh Basoor, Singapore (SG); Peng Yam Ng, Singapore (SG); Wee Sin Tan, Singapore (SG); Wong Chiap Loong, Singapore (SG)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/896,829

(22) Filed: Jul. 22, 2004

(51) Int. Cl. G01J 5/00

(52) U.S. Cl. 250/338.1

(57) ABSTRACT

According to at least one embodiment of the invention, a method includes mounting a transmitting device and a receiving device on a circuit board, wherein the circuit board includes a layer that blocks waves (e.g., light waves) emitted from the transmitting device, and wherein the transmitting device and the receiving device are mounted in an area defined by the layer. The method further includes manipulating a structure to form a first compartment for the transmitting device and a second compartment for the receiving device, wherein the compartments are separated by a common wall such that each compartment is continuous with at least part of the common wall. The method further comprises mounting the structure on the circuit board. According to this embodiment, the transmitter and the receiver may be part of a proximity sensor, and the layer that blocks waves, the first and second compartments, and the common wall (which may be a folded double wall) operate to prevent cross-talk between the transmitter and the receiver.

### TECHNICAL FIELD

This invention relates in general to preventing cross-talk between a transmitter and a receiver, and specifically, to preventing cross-talk in an infrared proximity sensor.

### BACKGROUND OF THE INVENTION

Proximity sensors may be found in various applications, from consumer products to commercial and industrial machines. Traditional proximity sensors usually include one transmitter and one receiver that are placed such that their respective transducers both point outward to a detection region. When an object moves in front of the proximity sensor, it reflects light from the transmitter, some of which is picked up by the receiver. When the receiver picks up light from the transmitter, it sends a signal that is interpreted as indicating that an object is present.

An issue that often arises with proximity sensors is the phenomenon of cross-talk. Cross-talk, in many traditional applications, may be considered to be when light from a transmitter is detected by a receiver without first having been reflected off of an object in the detection zone. Cross-talk is often associated with stray light and unwanted light reaching the receiver, which may hamper the sensor's accuracy and degrade performance.

A traditional approach for reducing cross-talk is to place a piece of material between the transmitter and the receiver or to try to surround each of the transmitter and receiver with separate light-blocking structures that are not continuous with respect to the piece of material that separates the transmitter and receiver. Further, proximity sensors mounted on Printed Circuit Boards (PCBs) may experience some cross-talk from light that is transmitted through the material of the PCB.

### BRIEF SUMMARY OF THE INVENTION

According to at least one embodiment of the invention, a method includes mounting a transmitting device and a receiving device on a circuit board, wherein the circuit board includes a layer that blocks waves (e.g., light waves) emitted from the transmitting device, and wherein the transmitting device and the receiving device are mounted in an area defined by the layer. The method further includes manipulating a structure to form a first compartment for the transmitting device and a second compartment for the receiving device, wherein the compartments are separated by a folded double wall that is continuous with each compartment. The method further comprises mounting the structure on the circuit board. According to this embodiment, the transmitter and the receiver may be part of a proximity sensor, and the layer that blocks waves, the first and second compartments, and the double wall operate to prevent cross-talk between the transmitter and the receiver.

According to another embodiment, an apparatus comprises a transmitter, a receiver, and a Printed Circuit Board (PCB), wherein the PCB includes a layer of material that blocks electromagnetic waves from the transmitter, and wherein the transmitter and receiver are mounted on the PCB in an area defined by the layer. Accordingly, this embodiment may operate to prevent electromagnetic waves from the transmitter from reaching the receiver through the PCB, thereby preventing cross-talk.

According to yet another embodiment, an apparatus comprises a piece of material manipulated to form two compartments, a folded double wall separating the two compartments, wherein the double wall is continuous with each of the two compartments, and a transmitter and a receiver, wherein each of the transmitter and receiver are substantially within a volume defined by one of the compartments. The two compartments and the double wall may form a shield, which operates to prevent cross-talk. The continuousness of the double wall and the two compartments may function to ensure that waves from one compartment do not reach the other compartment without first being reflected from an object in the detection zone.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

FIG. 1 is an illustration of a shield, adapted according to various embodiments, for preventing cross-talk between a receiver and a transmitter;

FIG. 2 is an illustration of a manipulating process, adapted according to various embodiments, for forming a shield,

FIG. 3 is an illustration of an example system, wherein a shield is mounted on a PCB;

FIG. 4 is an illustration of an example proximity sensor unit, adapted according to various embodiments, for preventing cross-talk;

FIG. 5 is an illustration of an example proximity sensor unit, adapted according to various embodiments, for preventing cross-talk;

FIG. 6 is a flowchart illustrating an example method for preventing cross-talk;

FIG. 7 is a flowchart that depicts an example method, according to various embodiments, for preventing cross-talk;

FIG. 8 is an illustration that depicts an example application that employs a proximity sensor unit, adapted according to various embodiments.

### DETAILED DESCRIPTION OF THE INVENTION

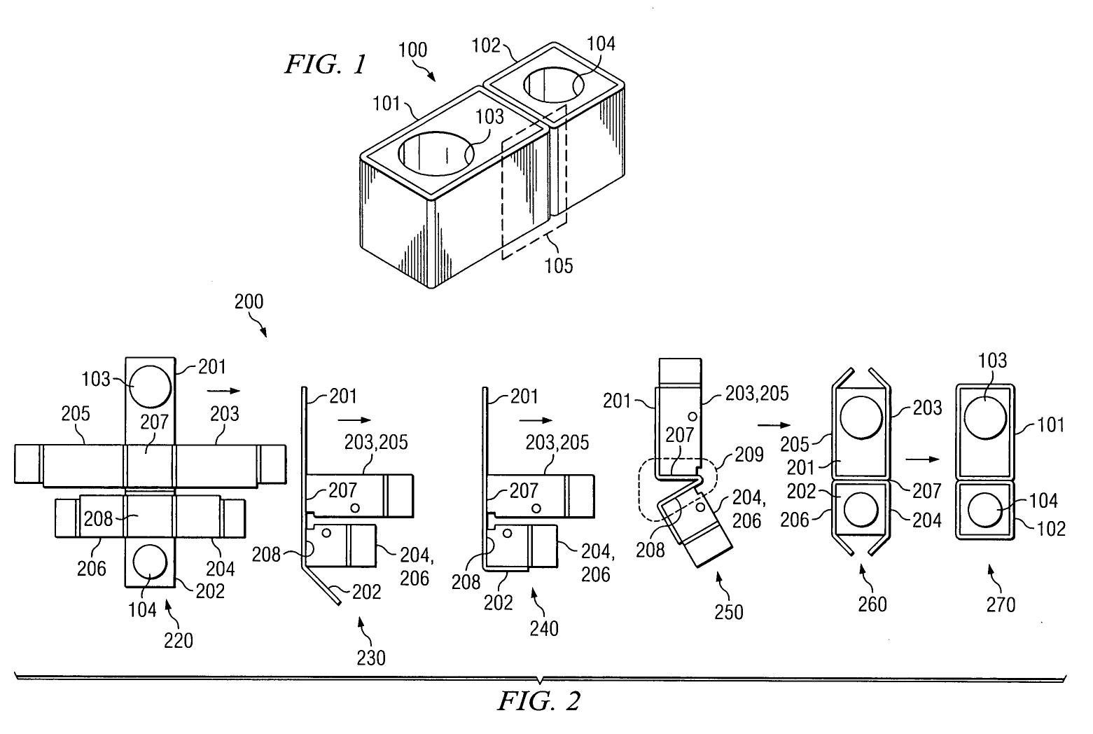

FIG. 1 is an illustration of shield 100, adapted according to various embodiments, for preventing cross-talk between a receiver and a transmitter. Shield 100, in this example, is constructed from material that is manipulated to form compartments 101 and 102. An example construction is discussed below with regard to FIG. 2. Area 105 of shield 101 depicts the separation between compartments 101 and 102, and, as will be explained below, compartments 101 and 102 are separated by a common wall structure, wherein each of the compartments are continuous with the wall structure. The common wall structure cannot be seen in FIG. 1, but an example is seen in FIG. 2, as a folded double wall.

In this particular embodiment, shield 100 is designed to prevent cross-talk between a receiver (RX) and a transmitter (TX) (not shown in FIG. 1), when each of the TX and RX are substantially within a volume of one of the compartments. In this example, an RX may be placed in compartment 101, and a TX may be placed in compartment 102. That each of the TX and RX are substantially within a volume of one of the compartments means that some, but not necessarily all, of each of the TX and RX apparatuses are located inside the compartments, while being sufficiently located within compartments 101 and 102 such that the common wall structure can act as a barrier to prevent cross-talk. For example, in some embodiments, the transducers of each of the TX and RX will be located in compartments, whereas the wires that are in electrical communication with the transducers to carry signals and power may be routed outside of the compartments. Alternative embodiments may employ other arrangements, and all are within the scope of the invention as long as shield 100 can, by itself or with other components, be used to reduce or prevent cross-talk.

Aperture 104 allows the TX to transmit electromagnetic waves outside of shield 100, and aperture 103 allows the RX to receive electromagnetic waves from outside shield 100. In this example, the TX and RX may be part of a proximity sensor, such that an object that is in front of apertures 103 and 104 (i.e., in the detection region) will reflect waves from the TX, and the RX will receive at least some of the reflected waves from the object. When the RX receives waves from the TX it signals that an object is near. Accordingly, in many embodiments it is undesirable for the RX to receive waves from the TX that have not been reflected from an object in the detection region because the reception of those waves will trigger a false indication (i.e., cross-talk). Cross-talk may sometimes be referred to as “direct communication” between the transmitter and receiver, though the waves may be reflected from one or more surfaces other than an object in the detection region.

Shield 100 acts to prevent cross-talk by blocking waves from the TX to the RX that are not reflected from an object in the detection region. Specifically, the walls of compartments 101 and 102, including the common wall structure separating the compartments, act to isolate the RX from the waves emitted from the TX, unless, of course, those waves are received through aperture 103. As explained further below, shield 100 may be combined with a TX and RX and mounted to a circuit board to produce a proximity sensor unit for use in a variety of applications, although applications that use a transmitter and a receiver for other than proximity sensing are within the scope of various embodiments.

FIG. 2 is an illustration of manipulating process 200, adapted according to various embodiments, for forming shield 100. Manipulating process 200 includes steps 220, 230, 240, 250, 260, and 270.

In step 220, the structure is a single piece of material that is laid flat, and it can be seen that the material includes sections 201-208. Apertures 103 and 104 may be seen as cut-out areas of sections 201 and 202, respectively. In step 230, the material is folded such that sections 201, 202, 207, and 208 are bent 90 degrees from sections 203 and 204 and appear as nearly one-dimensional lines. Sections 205 and 206 are folded an additional 90 degrees such that they are directly above sections 203 and 204 in this view. Section 202 is also bent part of the way toward sections 204 and 206.

In step 240, section 202 is bent the rest of the way toward sections 202 and 204. Section 201 will be bent in a similar manner toward sections 203 and 205, as seen in step 250. It should be noted that the volume defined by sections 202, 204, 206, and 208 will be used to form compartment 102, and the volume defined by sections 201, 203, 205, and 207 will be used to form compartment 101. Also in step 250, the structure is bent such that sections 207 and 208 form an acute angle. As can be seen in step 250, sections 207 and 208 are used to form folded double wall 209 that was mentioned with respect to FIG. 1. Accordingly, folded double wall 209 may be referred to as a “reverse-bend folded double wall.” In step 260, the structure is shown with surfaces 201 and 202 facing the viewer. In this step, the structure is bent such that sections 207 and 208 are touching or nearly touching, thus forming folded double wall 209. Further, the end portions of sections 203-206 are bent toward the structure. Step 270 shows the final shape of the structure, which can be recognized as shield 100. The difference between the result of step 260 and step 270 is that in step 270, the end portions of sections 203-206 are bent to enclose sections 101 and 102.

Two items should be noted regarding shield 100 as formed in steps 220-270. First, shield 100 may be formed such that folded double wall 209 is continuous with compartments 101 and 102. A result is that there are no gaps where sections 203 and 205 join section 207, and the same can be said for sections 204, 206, and 208. The continuousness of the material that results in the lack of gaps and the folded double wall provides a more complete separation of the TX and RX, and helps to assure that in some embodiments, no waves (or very few waves) will penetrate compartment 101 from compartment 102, such that cross-talk is prevented. That wall 209 is a double wall helps to ensure that the material is thick enough to stop all (or nearly all) waves from passing directly from compartment 102 to compartment 101. The continuousness also means that shield 100 can be formed from a single piece of material, as shown in FIG. 2.

The second item that should be noted is that step 270 provides a view of shield 100 from the top (or detection area) only, and that the bottom of shield 100 is not enclosed. In other words, each compartment is open both at its respective aperture 103 or 104 and at its bottom side. As explained further below, various embodiments may employ one or more techniques to prevent cross-talk occurring through the bottom side when mounting shield 100 on a Printed Circuit Board (PCB).

In an example embodiment, the length of compartments 101 and 102 together is about 7 mm, while the height and width are each about 3 mm. The length of compartment 101, in this embodiment, is 4 mm, while the length of compartment 102 is 3 mm. Compartment 102 may be larger than compartment 101 in order to accommodate an RX that is slightly larger than a corresponding TX. Thus, a proximity sensor contained in shield 100 is of a small size and may be deployed in various consumer, business, and industrial applications without occupying a large volume. Also, in this example embodiment, the material may be constructed of stainless steel that is 0.1 mm thick. Such a construction may provide adequate cross-talk shielding for a variety of proximity sensors, including proximity sensors that operate in the infrared (IR) frequency band. Other embodiments may employ different materials and/or thicknesses, and all are within the scope of embodiments as long as the qualities chosen provide adequate shielding for the intensity and frequency of the waves used in the particular application. For example, alternate embodiments may use metals other than stainless steel or may use plastics or ceramics. However, stainless offers many advantages not offered by some other materials, such as resistance to corrosion, hardness, stiffness, and the ability to retain its shape after folding.

Although the previous example (along with other examples below) illustrates an embodiment wherein shield 100 is a single-piece structure with a folded double wall, alternative embodiments may employ other forms for shield 100 that include a common wall structure, wherein each compartment is continuous with at least part of the wall structure. For example, an alternative embodiment may be similar to that depicted in FIG. 2, but with the fold in wall 209 cut such that the wall (and shield 100 itself) are split in two separate pieces. In this example embodiment, wall 209 is still a common wall structure, since both halves are included in shield 100, and each compartment is still continuous with its corresponding half of wall 209. In another alternative embodiment, wall 209 may be a quadruple wall from having extra material that is folded twice, rather than once (notice it is folded once on step 250). Numerous other embodiments not specifically disclosed herein, are also within the scope of various embodiments of the present invention.

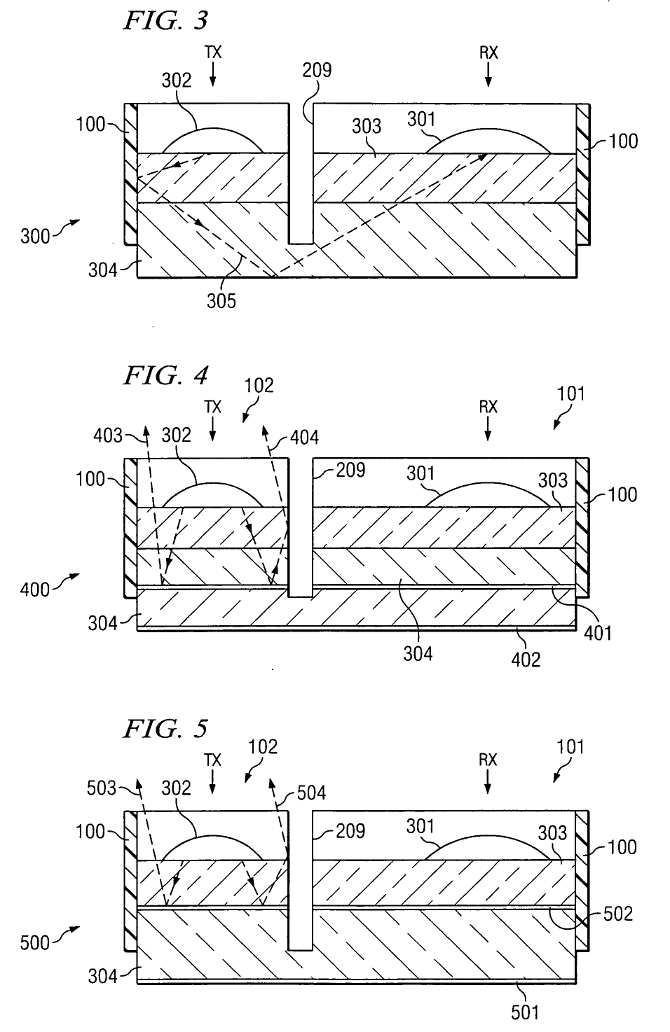

FIG. 3 is an illustration of example system 300, wherein shield 100 is mounted on PCB 304. Notice that the walls of shield 100 (including double wall 209) extend through a portion of the depth of PCB 304. In this example, TX 302 and RX 301 are substantially within a volume defined by shield 100, and also mounted on PCB 304. Further, TX 302 and RX 301 may be part of single-piece proximity sensor, wherein TX 302 and RX 301 are in a single package and are coupled to one another such that one TX/RX component is mounted on PCB 304, rather than each of TX 302 and RX 301 being mounted separately. A layer of molding 303 is on top of PCB 304, and it functions to physically hold TX 302 and RX 301 in place while also collimating the light waves for better performance. In this example, it may be made of an epoxy-based plastic.

In many practical applications, a proximity sensor (or other type of TX and RX) will be mounted on a PCB, similar to other components that make up an electronic device. Such an arrangement may allow the proximity sensor to interface with the power and control systems of the device while benefiting from the structural support offered by the PCB. Wires to send and receive signals by TX 302 and RX 301 are not shown in this example for simplicity; however, practical applications may employ a number of hard-wired connections that extend through at least a portion of PCB 304, and those applications are within the scope of various embodiments. PCBs, such as PCB 304, are usually made out of fiberglass, and are, therefore, usually light-conductive. It is the light-conductive property of PCB 304 that facilitates cross-talk in example system 300. Thus, IR light wave 305 travels through PCB 304 from TX 302 to RX 301, reflecting on the inside of shield 100 and the bottom of PCB 304, thereby causing RX 301 to indicate (falsely) that an object is nearby.

Accordingly, to further prevent cross-talk, it may be desirable to implement another light-blocking structure to further isolate RX 301 from waves that travel through PCB 304 from TX 302. FIG. 4 is an illustration of example proximity sensor unit 400, adapted according to various embodiments, for preventing cross-talk. Proximity sensor unit 400 is similar to system 300 in that TX 302, RX 301, and shield 100 are mounted on PCB 304. Proximity sensor unit 400, however, adds copper layers 401 and 402. Copper layer 401 acts as a light-blocking layer to reduce cross-talk by further isolating RX 301 from the electromagnetic waves from TX 302. TX 302 and RX 301 are mounted on PCB 304 in an area defined by copper layer 401. In this example embodiment, copper layers 401 and 402 may extend in any direction as far as PCB 304 extends, as long as copper layer 401 contains the footprint of shield 100.

In this example, copper layer 401 runs between two layers of PCB 304, and shield 100 is mounted such that its walls (including double wall 209) extend below copper layer 401. In this way, compartment 101, folded double wall 209, and copper layer 401 act to surround RX 301, and compartment 102, folded double wall 209, and copper layer 401 act to surround TX 302. Accordingly, in this example, IR waves 403 and 404 are not able to pass through PCB 304 from TX 302 to RX 301. Instead, IR waves 403 and 404 are blocked by copper layer 401 and reflected such that they exit shield 100 at aperture 104 (FIG. 1). This helps to ensure that the waves received by RX 301 are reflected from an object in the detection range, rather than from cross-talk.

Many PCBs are sold on the market with a thin copper layer on both the top and the bottom. Accordingly, an example technique to make proximity sensor unit 400 may include acquiring two PCBs, each with two copper layers. The PCBs are then bolted together, such that there is a single copper layer on top, then a PCB layer below that, then two copper layers below the PCB layer, then the bottom PCB layer, which has a single layer of copper on its bottom surface. The topmost and bottommost copper layers may then be etched to form circuits, leaving a PCB-mounted circuit, which includes two copper layers sandwiched between two PCB layers.

Accordingly, in such an example embodiment, copper layer 401 may actually be two copper layers, and copper layer 402 may be etched to form circuits. In example unit 400, the topmost copper layer is not shown because it has been etched to form circuits, while copper layer 402 has not been etched. In the example embodiment depicted as system 400, copper layer 401 is 20-30 microns thick, which is adequate to block light from some IR transmitters. Alternative embodiments may use other thicknesses, number of layers, or other types of waves in the electromagnetic spectrum, and all are within the scope of embodiments, as long as the light-blocking layer blocks light in an adequate manner for the application in which it is disposed.

Using one or more copper layers as a light-blocking structure, in some embodiments, may have both desirable and undesirable effects. For instance, while copper is a good light-blocking substance for some applications, it may produce extra cost in the manufacturing process by dulling blades used to cut the boards. It should be noted that boards may be cut during manufacture to produce desired sizes, and also during the mounting process to accommodate components which must extend below the surface of the topmost layer. Further, one or more copper layers in a board may fail to cut in a smooth manner, thereby leaving jagged edges (called “burrs”) which may unintentionally make electrical contact with elements mounted on the board. Accordingly, another light-blocking material may be desirable in some applications.

FIG. 5 is an illustration of example proximity sensor unit 500, adapted according to various embodiments, for preventing cross-talk. Proximity sensor unit 500 is similar to system 300 and unit 400 in that all mount TX 302, RX 301, and shield 100 on PCB 304. Example unit 500 is different from example unit 400, because system 500 includes light-blocking soldermask layers 501 and 502 and omits copper layers.

In this example embodiment, shield 100 is mounted such that the walls of shield 100 (including double wall 209) extend below layer 502. In this manner, compartment 101, folded double wall 209, and layer 502 act to surround RX 301, and compartment 102, folded double wall 209, and layer 502 act to surround TX 302. Accordingly, IR waves from TX 302 are prevented from reaching RX 301 through PCB 304 because they are reflected from layer 502 and shield 100. Thus, cross-talk is prevented.

In various PCB applications, soldermask may be used as an insulator that is applied to the circuits on an etched PCB in order to protect those circuits from electrical contact with other conductors. There are various varieties of soldermask, including dry-film and liquid. In this example embodiment, wherein TX 302 emits IR light, it is important that the soldermask chosen for the light-blocking layer be able to block IR light. Similarly, for applications that use other electromagnetic frequencies, it is important to select a soldermask for the light-blocking layer that is operable to block light in that frequency range. Soldermask layer 501 is optional, but may be applied as a redundant mechanism to block any waves which might otherwise penetrate PCB 304 and layer 402.

In some applications, soldermask may provide one or more desirable qualities. For instance, it may be an excellent light-blocking material, even when applied in thin layers. Further, it may avoid dulling cutting blades or producing burrs, as with copper layers. Additionally, the cost of soldermask may make it an economically attractive material for the manufacture of such applications.

FIGS. 4 and 5 both depict systems for preventing cross-talk using one or more light-blocking layers applied to a PCB. Alternative embodiments may utilize other materials, thicknesses, and electromagnetic frequencies. It should be noted that the various embodiments herein are not limited to the specific embodiments disclosed. For instance, an embodiment which uses opaque materials, rather than reflective materials, to block light is within the scope of the embodiments. Further, an embodiment which uses a material other than copper or soldermask to block light, or an embodiment which uses radio waves, microwaves, or the like also falls within the scope of the embodiments.

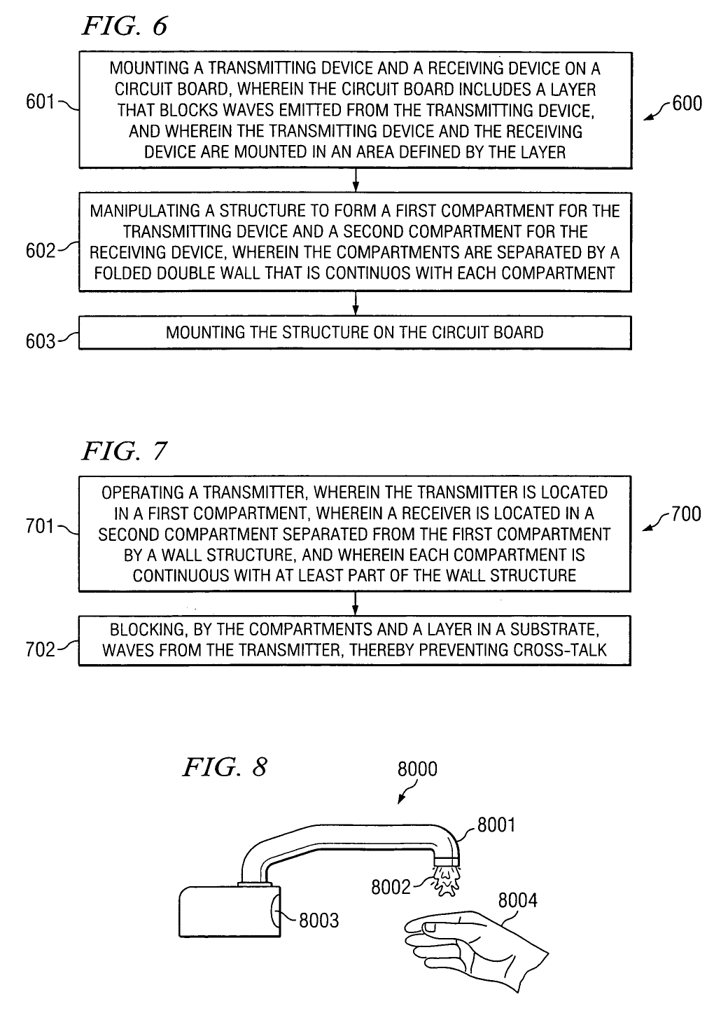

FIG. 6 is a flowchart illustrating example method 600 for preventing cross-talk. In block 601, a transmitting device and a receiving device are mounted on a circuit board, wherein the circuit board includes a layer that blocks waves emitted from the transmitting device, and wherein the transmitting device and the receiving device are mounted in an area defined by the layer. Various techniques for mounting the transmitting device and the receiving device are within the scope of various embodiments, including manual mounting. The circuit board may be any of a variety of circuit boards, including, for example, a PCB. In an example embodiment, the transmitting device and the receiving device are IR-frequency devices and are included as part of a proximity sensor.

In block 602, a structure is manipulated to form a first compartment for the transmitting device and a second compartment for the receiving device, wherein the compartments are separated by a folded double wall that is continuous with each compartment. In an example embodiment, after the manipulating, the structure is similar to shield 100 (FIG. 1), and the folded double wall is similar to wall 209 (FIG. 2). The manipulating may include, for example, folding, bending, creasing, and the like, as long as the particular technique is suitable for forming the compartments from the material used to construct the structure.

In block 603, the structure is mounted on the circuit board. The structure may be mounted on the circuit board with any of a variety of techniques suitable for the mounting, such as a customized pick and place technique utilizing glue to attach the shield to the PCB. As in the embodiments depicted in FIGS. 4 and 5, the structure may be mounted such that its footprint is entirely within the area defined by the light-blocking layer and wherein each compartment is aligned with the TX or RX, respectively. Further, the structure may be mounted before or after the transmitting and receiving devices are mounted, depending on the particular manufacturing technique that is chosen.

Mounting the structure as described above, with a folded double wall that is continuous with each of two compartments, may be advantageous compared to mounting a structure wherein the compartments are separate. For example, the continuousness of the material may help to eliminate some alignment issues that would be present in mounting a shield wherein the compartments are separate. Also, as explained above, the continuousness of the metal helps to eliminate gaps that might let electromagnetic waves penetrate the shield and cause cross-talk.

FIG. 7 is a flowchart that depicts method 700, according to various embodiments, for preventing cross-talk. In block 701, a transmitter is operated, wherein the transmitter is located in a first compartment, wherein a receiver is located in a second compartment separated from the first compartment by a wall structure, and wherein each compartment is continuous with at least part of the wall structure. In an example embodiment, the wall structure is a folded double wall structure, and the compartments form a shield, as seen in FIG. 2. Further, the transmitter may be operated, for example, by causing it to emit electromagnetic waves, such as IR waves.

In block 702, the compartments and a layer in a substrate block waves from the transmitter, thereby preventing cross-talk. In an example embodiment, the substrate is a PCB, and the layer is soldermask layer that is operable to block IR light waves. The compartments may form a shield that is mounted on the PCB. While waves are blocked in this example, some waves may still reach the receiver from the transmitter by being reflected off of an object in the detection zone.

FIG. 8 depicts an example application that employs a proximity sensor, adapted according to various embodiments. Water faucet 800 is an automatic, touchless faucet, similar to those found in washrooms worldwide. However, faucet 800 employs a proximity sensor unit, adapted according to various embodiments, which is disposed behind protective, IR-transparent cover 803.

The elimination of cross-talk provided by shield 100 (FIG. 1) may facilitate the use of a more sensitive (and, therefore, more precise) proximity sensor. A control system (not shown) can be programmed to control water flow 802 from opening 801 according the presence or absence of hand 804. Eliminating water flow 802 when hand 804 is not under opening 801 may help conserve water and protect the environment.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method comprising:
mounting a transmitting device and a receiving device on a substrate, wherein the substrate includes a layer that blocks waves emitted from the transmitting device, and wherein the transmitting device and the receiving device are mounted in an area defined by the layer;
manipulating a structure to form a first compartment for the transmitting device and a second compartment for the receiving device, wherein the compartments are separated by a common wall, and wherein each compartment is continuous with at least part of the common wall; and
mounting the structure on the substrate.

2. The method of claim 1 wherein the substrate is a circuit board.

3. The method of claim 1 wherein the structure is made of a single piece of material.

4. The method of claim 1 wherein the common wall is a folded double wall.

5. The method of claim 1 wherein mounting the structure is performed before mounting the transmitting and receiving devices.

6. The method of claim 1 wherein manipulating the structure comprises bending the structure.

7. The method of claim 1 further comprising operating the transmitting device and the receiving device as a proximity sensor.

8. The method of claim 7 further comprising employing the proximity sensor in a water faucet.

9. The method of claim 1 wherein mounting the structure comprises aligning the structure so that its footprint is within the area defined by the layer.

10. The method of claim 1 wherein the layer comprises a metallic layer or a soldermask layer.

11. The method of claim 1 wherein the layer blocks waves from direct communication with the receiving device.

12. The method of claim 1 wherein the transmitting device and the receiving device are in a single package and are coupled to one another, such that mounting the transmitting device and the receiving device on a circuit board comprises mounting a single transmitter/receiver unit.

13. An apparatus comprising:
a transmitter;
a receiver; and
a Printed Circuit Board (PCB), wherein the PCB includes a layer of material that blocks wireless communication from the transmitter, and wherein the transmitter and receiver are mounted on the PCB in an area defined by the layer.

14. The apparatus of claim 13 wherein the layer of material comprises a liquid soldermask.

15. The apparatus of claim 13 wherein the layer of material comprises one or more metallic layers.

16. The apparatus of claim 15 wherein at least one metallic layer comprises copper.

17. The apparatus of claim 13 wherein wireless communication is infrared waves.

18. The apparatus of claim 13 wherein the transmitter and receiver are part of a single-piece proximity sensor.

19. The apparatus of claim 13 further comprising a shield mounted on the PCB in the area defined by the layer of material.

20. The apparatus of claim 19 wherein the transmitter, the receiver, the PCB, and the shield are included in a proximity sensor unit.

21. An apparatus comprising:
two compartments;
a common wall separating the two compartments, wherein the each compartment is continuous with at least part of the common wall;
a transmitter, wherein the transmitter is substantially within a volume defined by one of the compartments; and
a receiver, wherein the receiver is substantially within a volume defined by the other compartment.

22. The apparatus of claim 21 wherein the transmitter, the receiver, and the compartments are mounted on a Printed Circuit Board (PCB).

23. The apparatus of claim 22 wherein the PCB includes a layer that blocks waves emitted from the transmitter.

24. The apparatus of claim 23, wherein the compartments and the layer are operable to prevent cross-talk between the transmitter and the receiver.

25. The apparatus of claim 21 wherein the compartments comprise a single piece of material, and wherein the compartments and the common wall are formed by bending the piece of material.

26. The apparatus of claim 21 wherein the compartments comprise stainless steel.

27. The apparatus of claim 21 wherein each of the two compartments includes an aperture.

28. The apparatus of claim 21 wherein the common wall is a folded double wall.

29. A method comprising:
operating a transmitter, wherein the transmitter is located in a first compartment, wherein a receiver is located in a second compartment separated from the first compartment by a wall structure, and wherein each compartment is continuous with at least part of the wall structure; and
blocking, by the compartments and a layer in a substrate, waves from the transmitter, thereby preventing cross-talk.

30. The method of claim 29, wherein the wall structure is a folded double wall structure.

31. The method of claim 29, wherein the substrate is a Printed Circuit Board (PCB), the layer is a copper layer, and the compartments are mounted on the PCB.

32. The method of claim 29 wherein the transmitter and receiver are operated as a proximity sensor.

33. A system for preventing cross-talk between a transmitter and a receiver comprising:
means for separating the transmitter and receiver with a common wall; and
means for mounting the transmitter, the receiver, and the means for separating the transmitter and the receiver on a Printed Circuit Board (PCB), wherein the PCB includes a layer that blocks electromagnetic waves emitted by the transmitter.

34. The system of claim 33 wherein the means for separating the transmitter and receiver comprise a structure, wherein the common wall is a folded double wall that is part of the structure, wherein the structure includes a first compartment for the transmitter and a second compartment for the receiver, and wherein the double wall is continuous with each of the compartments.

35. The system of claim 34, wherein the compartments, the folded double wall, and the layer surround each of the transmitter and receiver, except for an aperture for each of the transmitter and receiver, thereby preventing cross-talk.
